(19) United States
(12) Patent Application Publication
(10) Pub. No.: US 2007/0070100 A1
(43) Pub. Date: Mar. 29, 2007

(54) Inkjet image forming apparatus and method of compensating for defective nozzle

(75) Inventor: Terekhov Vladislav, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/527,540

(22) Filed: Sep. 27, 2006

(30) Foreign Application Priority Data
Sep. 28, 2005 (KR) 10-2005-0090708

(51) Int. Cl. B41J 29/38

(52) U.S. Cl. 347/9

(57) ABSTRACT

An inkjet image forming apparatus and method of compensating for a defective nozzle in an inkjet image forming apparatus are provided. By analyzing firing states of nozzles firing ink at a compensated position, which is a position printed with the defective nozzle, and at positions adjacent to the compensated position, and by firing ink having a color different from that of the defective nozzle at the compensated position according to the firing states of the nozzles to diffuse the ink fired at the adjacent positions into the compensated position, the defective nozzle is compensated. Accordingly, the missing dot of the defective nozzle is compensated for, so that it is possible to prevent deterioration in image quality such as a white band which can be easily perceived by a user. In addition, by adjusting a firing amount or chroma of the ink fired at the compensated position or the adjacent positions, it is possible to improve a compensation effect.

### CROSS-REFERENCE TO RELATED PATENT APPLICATION

This application claims the benefit under 35 U.S.C. § 119(a) of Korean Patent Application No. 10-2005-0090708, filed in the Korean Intellectual Property Office on Sep. 28, 2005, the entire disclosure of which is incorporated herein by reference.

### BACKGROUND OF THE INVENTION

1. Field of the Invention

The present invention relates to an inkjet image forming apparatus. More particularly, the present invention relates to an inkjet image forming apparatus capable of compensating for deterioration in image quality caused by the occurrence of a defective nozzle, and a method of compensating for the defective nozzle occurrence in the inkjet image forming apparatus.

2. Description of Related Art

In general, inkjet image forming apparatuses are apparatus for forming an image by firing ink with a print head which is separated by a predetermined interval from a printing medium and which reciprocates in a direction perpendicular to a conveying direction of the printing medium. Such an inkjet image forming apparatus for forming an image by firing ink on the printing medium with the print head reciprocating in a direction perpendicular to a conveying direction of the printing medium is called a shuttle type inkjet image forming apparatus. The print head of the shuttle type inkjet image forming apparatus is provided with a nozzle unit including a plurality of nozzles for firing ink.

Recently, attempts have been made to implement high speed printing by using a print head having a nozzle unit corresponding to a width of a printing medium instead of using a print head reciprocating in a width direction of the printing medium. Image forming apparatuses operating in such a manner are called line printing type inkjet image forming apparatuses. In the line printing type inkjet image forming apparatuses, the print head is fixedly disposed and only the printing medium is conveyed. Therefore, driving mechanisms of the inkjet image forming apparatus are simple, and high speed printing can be implemented.

FIG. 1 is a view showing a print pattern at the time of occurrence of a defective nozzle in a conventional inkjet image forming apparatus, and FIGS. 2A to 2D are views showing a method of compensating for the defective nozzle occurrence in the conventional inkjet image forming apparatus.

Referring to FIG. 1, the inkjet image forming apparatus prints an image by firing ink I on a printing medium with nozzles 82 provided with a nozzle unit 80. If some of the nozzles 82 of the nozzle unit 80 have a defect, the ink I cannot be normally fired from the defective nozzle (for example, nozzle 84), so that missing lines occur on the printing medium, as shown in the figure. Namely, if some of the nozzles 82 have a defect, the ink I cannot be fired on printing regions of the printing medium printed by the defective nozzle 84, so that white bands such as missing lines occur. Since the white bands of an image printed on the printing medium can be easily seen, the white bands severely affect printing quality. A method of compensating for the deterioration in image quality caused by such a defective nozzle is disclosed in U.S. Pat. No. 5,581,284, issued Dec. 3, 1996, to Hermanson, the entire disclosure of which is incorporated herein by reference. FIGS. 2A to 2D correspond to FIGS. 3 to 6 of U.S. Pat. No. 5,581,284.

The invention disclosed in U.S. Pat. No. 5,581,284, includes a method of compensating for the occurrence of a defective nozzle in an inkjet image forming apparatus. Here, the defective nozzle denotes a missing nozzle which cannot fire ink or a nozzle which cannot normally fire ink, such as a weak nozzle of which a function has become weakened. In the invention disclosed in U.S. Pat. No. 5,581,284, in a case where defective monochrome (that is, black) nozzles (element 63 in FIG. 2A) are defective, when the defective nozzles must be used, other colors, that is, cyan, magenta, and yellow are sequentially printed on the regions which must be printed by the defective nozzles 63. The associated process is shown in FIGS. 2B, 2C, and 2D. Therefore, if the cyan, magenta, and yellow colors are printed on the same point, the black color can be represented. The process is called a process Black or a process Composite Black. However, the method cannot be used for a case where nozzles firing other color ink (that is, other than black ink) have a defect. In addition, in a case where any one of the nozzles used for compensation also has a defect, the compensation is performed with resulting colors such as red (yellow+magenta), green (cyan+yellow), and blue (cyan+magenta), that are different from the process Black, and severe detrimental effects on the print quality can result.

Therefore, a need exists for an effective system and method to improve the print quality by compensating for the defective nozzle.

### SUMMARY OF THE INVENTION

Embodiments of the present invention substantially solve the above and other problems, and provide an inkjet image forming apparatus and a method of compensating for a defective nozzle capable of improving image quality by compensating for the defective nozzle.

Embodiments of the present invention also provide an inkjet image forming apparatus and a method of compensating for a defective nozzle capable of minimizing influence of a defective nozzle on image quality by overcoming limitations of conventional compensating methods wherein only black colors can be compensated.

Embodiments of the present invention also provide an inkjet image forming apparatus and a method of compensating for a defective nozzle capable of prolonging the life time of a print head.

According to an aspect of embodiments of the present invention, a method of compensating for a defective nozzle in an inkjet image forming apparatus having a nozzle unit for firing ink on a printing medium to print an image is provided, comprising detecting the occurrence of the defective nozzle in the nozzle unit and when the defective nozzle is detected, analyzing the firing state of nozzles firing ink at a compensated position, which is a position printed with the defective nozzle, and at positions adjacent to the compensated position. The method compensates for the defective nozzle by firing ink having a color different from that of the defective nozzle at the compensated position according to the firing states of the nozzles to diffuse the ink fired at the adjacent position or positions into the ink fired at the compensated position.

In the above aspect of embodiments of the present invention, the method can further comprise, when the defective nozzle is detected, performing a maintenance operation to recover the nozzle unit to a printing standby state.

In addition, the method can further comprise, after the maintenance operation is performed, detecting the continued occurrence of the defective nozzle in the nozzle unit.

In addition, ink having a color equal to that of the ink fired from the defective nozzle can be fired at the adjacent position. In addition, at least one of the inks fired at the adjacent positions and the ink fired at the compensated position can have a larger firing amount than an amount of normally fired ink.

In addition, ink having chroma similar to that of the ink fired from the defective nozzle can be fired at the compensated position.

In addition, ink having two or more colors may be fired at the compensated position.

In addition, where the defective nozzle is a black nozzle firing a black ink, black ink can be fired at the adjacent position or positions.

In addition, if a black nozzle adjacent to the defective nozzle is a defective nozzle, cyan, magenta, and yellow ink can be fired at the adjacent position.

In addition, at least one of the inks fired at the adjacent position or positions and the ink fired at the compensated position can have a larger firing amount than an amount of normally fired ink.

In addition, ink having chroma similar to that of the ink fired from the defective nozzle can be fired at the compensated position.

In addition, cyan, magenta, and yellow ink can be fired at the adjacent position or positions.

In addition, the compensation for the defective nozzle further comprises determining, based on a to-be-printed image and the firing states of the nozzles, whether or not ink is fired at the adjacent position or positions and compensating for the defective nozzle by firing ink having a color equal to that of the defective nozzle at a position where ink is not fired among the adjacent positions.

In addition, the nozzle unit can have a length that is greater than or equal to a width of the printing medium.

According to another aspect of embodiments of the present invention, an inkjet image forming apparatus is provided comprising a print head having a nozzle unit for firing ink, a driving means for driving the nozzle unit to form an image on the printing medium, a defective nozzle detection unit for detecting the occurrence of a defective nozzle in the nozzle unit, and a control unit for controlling an operation of the driving means so that ink having a color different from that of ink fired from the defective nozzle is fired at a compensated position which is a position printed with the defective nozzle, and ink having a color equal to that of the ink fired from the defective nozzle is fired at positions adjacent to the compensated position.

In the above aspect of embodiments of the present invention, the inkjet image forming apparatus can further comprise a maintenance unit for recovering the nozzle unit to a printing standby state, wherein the control unit operates the maintenance unit when the defective nozzle is detected.

In addition, where the defective nozzle is a black nozzle for firing a black ink, the control unit can control an operation of the driving means to fire black ink at the adjacent positions.

In addition, the control unit can determine, based on a to-be-printed image and firing states of the nozzles, whether or not ink is fired at the adjacent position or positions and controls an operation of the driving means to fire ink having a color equal to that of the defective nozzle at a position where ink is not fired among the adjacent positions.

In addition, the nozzle unit can have a length that is greater than or equal to a width of the printing medium.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 is a view showing a print pattern in a case where a nozzle unit of a conventional line printing type inkjet image forming apparatus has a defect;

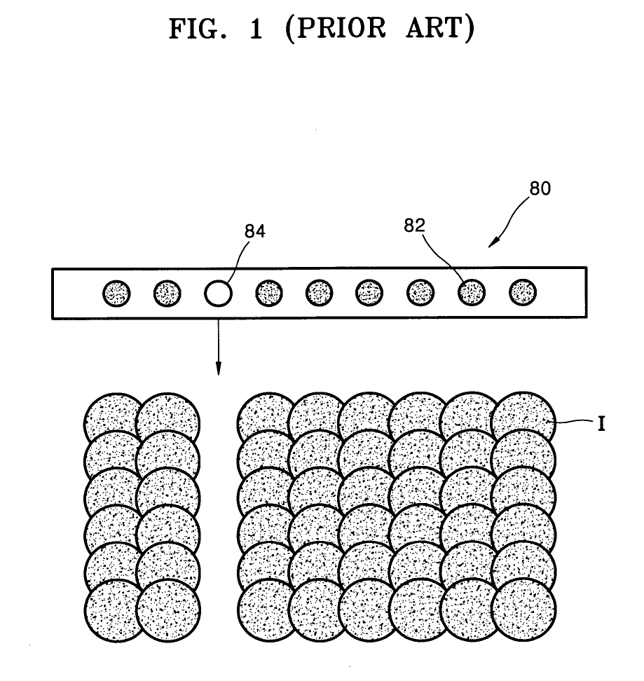

FIGS. 2A to 2D are views showing processes for compensating for the defective nozzle unit in the conventional inkjet image forming apparatus;

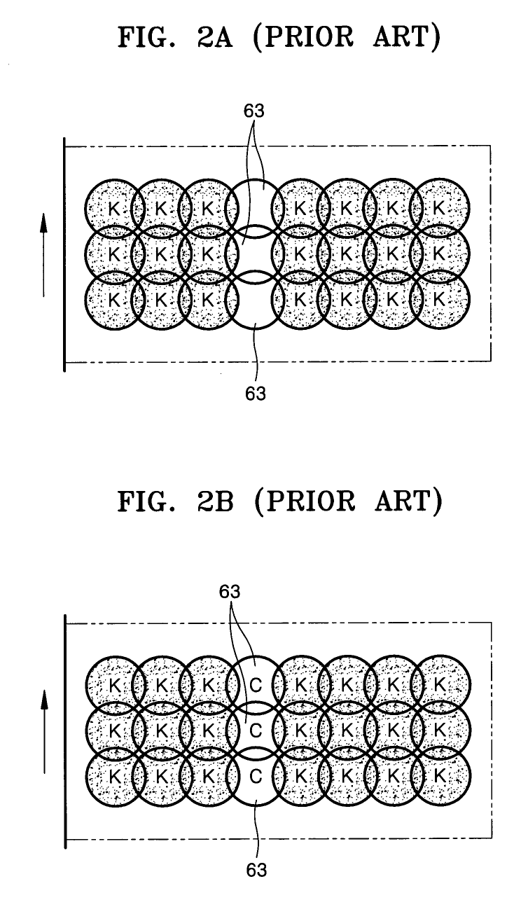

FIG. 3 is a schematic view showing an inkjet image forming apparatus according to an exemplary embodiment of the present invention;

FIG. 4 is a view showing a driving mechanism for a print head according to an exemplary embodiment of the present invention;

FIG. 5 is a plan view showing a print head according to an exemplary embodiment of the present invention;

FIG. 6 is a block diagram showing an image forming system according to an exemplary embodiment of the present invention;

FIG. 7 is a block diagram showing a construction of an inkjet image forming apparatus according to an exemplary embodiment of the present invention;

FIG. 8 is a flowchart showing a method of compensating for a defective nozzle in the inkjet image forming apparatus according to an exemplary embodiment of the present invention;

FIG. 9 is a view for illustrating a compensated position and positions adjacent thereto according to an exemplary embodiment of the present invention;

FIG. 10 is a view showing a to-be-printed print pattern in a method of compensating for a defective nozzle according to an exemplary embodiment of the present invention; and

FIGS. 11 to 14 are views for illustrating a method of compensating for a defective nozzle by implementing a to-be-printed print pattern as shown in FIG. 10 when the defective nozzle occurs according to an exemplary embodiment of the present invention.

Throughout the drawings, like reference numerals will be understood to refer to like parts, components and structures.

### DETAILED DESCRIPTION OF THE EXEMPLARY EMBODIMENTS

Now, an exemplary inkjet image forming apparatus and a method of compensating for a defective nozzle in the inkjet image forming apparatus according to embodiments of the present invention will be described in detail with reference to the accompanying drawings. For better understanding of the following description, a complete construction of an inkjet image forming apparatus will be first described, and an exemplary method of compensating for the defective nozzle in the inkjet image forming apparatus will then be described. In the drawings, the thicknesses of layers and regions are exaggerated for clarity. Meanings of terminology used herein should be determined in consideration of functionality of embodiments of the present invention, and may be variable depending on user's or operator's intention, or customs known to those skilled in the art. Therefore, corresponding meanings should be determined with reference to the entire specification. Like reference numerals in the drawings denote like elements, and thus their descriptions will not be repeated.

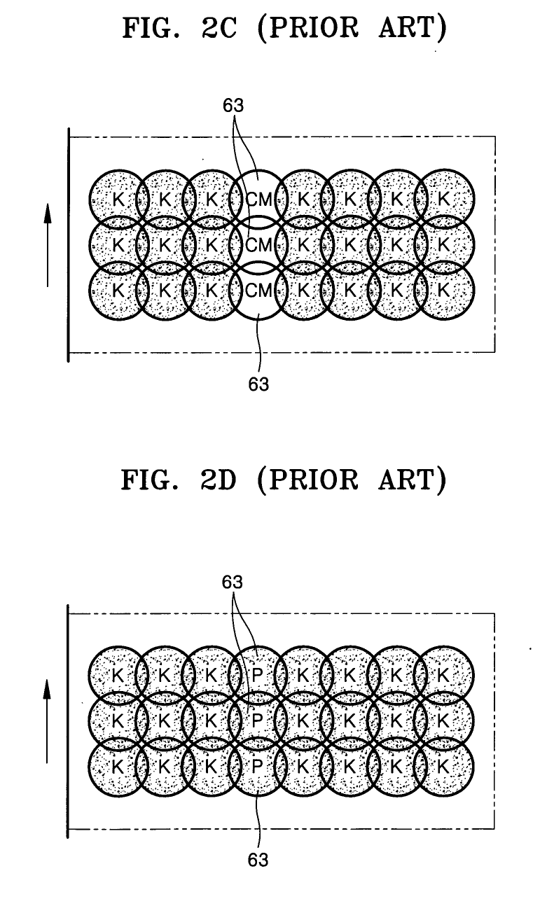

FIG. 3 is a schematic view showing an inkjet image forming apparatus according to an exemplary embodiment of the present invention.

Referring to FIG. 3, the inkjet image forming apparatus 125 comprises a paper-feeding cassette 120, a print head unit 105, a supporting member 114 facing the print head unit 105, a defective nozzle detection unit 132 for detecting the occurrence and positions of the defective nozzle of a nozzle unit 112, a printing medium conveying unit for conveying a printing medium P in a first direction (x direction), and a loading unit 140 in which an ejected printing medium P is loaded. In addition, the inkjet image forming apparatus 125 comprises a control unit 130 for controlling operations of components of the apparatus.

The printing medium P is loaded on the paper-feeding cassette 120. The printing medium P loaded on the paper-feeding cassette 120 passes through the print head 111 and is conveyed to the loading unit 140 by the printing medium conveying unit described in greater detail below. The loading unit 140 denotes components such as an ejected-paper tray on which the ejected printing medium P, on which an image is formed, is loaded.

The printing medium conveying unit, which is a component for conveying the printing medium P loaded on the paper-feeding cassette 120 along a predetermined path, comprises a pickup roller 117, auxiliary rollers 116, a feeding roller 115, and a paper ejecting roller 113. The printing medium conveying unit is driven by a driving source 131 such as a motor, and provides a conveying force which is exerted on the printing medium P. Operations of the driving source 131 are controlled by the control unit 130 as described in greater detail below.

The pickup roller 117 is disposed at one side of the paper-feeding cassette 120 and picks up and draws out sheets of the printing medium P loaded on the paper-feeding cassette 120 one-by-one. The feeding roller 115 is disposed at an input side of the print head 111 and feeds the printing medium P drawn out by the pickup roller 117 to the print head 111. The feeding roller 115 comprises a driving roller 115A for exerting a conveying force on the printing medium P, and an idle roller 115B which is elastically engaged with the driving roller 115A. A pair of auxiliary rollers 116 for conveying the printing medium P can be further disposed between the pickup roller 117 and the feeding roller 115.

The paper ejecting roller 113 is disposed at an output side of the print head 111 and ejects the printing-finished printing medium P from the image forming apparatus 125. The paper ejecting roller 113 comprises a star wheel 113A disposed in a width direction of the printing medium P, and a supporting roller 113B disposed to face the star wheel 113A to support a rear surface of the printing medium P. The star wheel 113A has a function of preventing the printing medium P (conveyed under the nozzle unit 112) from contacting the nozzle unit 112 or a bottom surface of a body 110, and preventing a gap between the printing medium P and the nozzle unit 112 from changing. Therefore, at least a portion of the star wheel 113A is disposed to protrude from the nozzle unit 112 and contact a front surface of the printing medium P in a point-wise contact manner. The printing medium P ejected from the image forming apparatus 125 is then loaded on the loading unit 140.

The supporting member 114 is disposed under the print head 111 so as to maintain a predetermined gap between the nozzle unit 112 and the printing medium P and supports the rear surface of the conveyed printing medium P. The gap between the nozzle unit 112 and the printing medium P is in a range of from about 0.5 mm to about 2.5 mm.

The defective nozzle detection unit 132 detects any defective nozzle occurring during manufacturing processes or printing operations. A defective nozzle denotes a nozzle which cannot normally fire ink such as a dead nozzle (which cannot fire ink), and a weak nozzle (which has a weak firing function). That is, the defective nozzle denotes a nozzle which cannot fire ink or a nozzle which fires a smaller amount of ink than an amount designated in design specifications. The defective nozzle can occur during manufacturing processes for the print head 111, or during the printing operations. In general, the information on the defective nozzle occurring during the manufacturing processes is separately stored in a memory (not shown) provided to the print head 111, and the information is transmitted to the image forming apparatus 125 when the print head 111 is mounted on the image forming apparatus 125.

The print head of the inkjet image forming apparatus is mainly classified into two types according to type of actuator for providing the firing force to the ink droplets. One is a thermal driving type where a heater is used to generate bubbles in the ink and fire ink droplets with an expansion force of the bubbles. The other is a piezoelectric driving type where a piezoelectric device is used to fire ink droplets using a pressure which is exerted on the ink due to deformation of the piezoelectric device. In the thermal driving type for firing the ink, it is easy to detect the defect of the nozzles generated due to a disconnection of the heater used to fire the ink, any disorder of a driving circuit for the heater, or any disorder of components such as field effect transistors (FETs) used therein. Similarly, in the piezoelectric driving type for firing the ink, it is easy to detect the defect of the nozzles generated due to any disorder of the piezoelectric device or disorder of a driving circuit for the piezoelectric device.

However, unlike the aforementioned cases, in some cases, such as a case where the nozzles are clogged with extraneous materials, the cause of an occurrence of the defective nozzle may not be easily determined. In such a case where the cause of the occurrence of the defective nozzle can not be easily determined, test page printing is performed. If the defective nozzle occurs, a printing concentration of portions printed with the defective nozzle is lower that that of portions printed with normal nozzles due to missing dots.

In an exemplary embodiment of the present invention, the defective nozzle detection unit 132 comprises a first detection unit 132A and a second detection unit 132B. In the exemplary embodiment, the first detection unit 132A detects whether or not the nozzles are clogged by illuminating light on the nozzle unit 112, and the second detection unit 132B detects the occurrence of the defective nozzle by illuminating light on the printing medium P. As an example, the defective nozzle detection unit 132 comprises an optical sensor (not shown). The optical sensor includes a light emitting sensor (for example, a light emitting diode) for illuminating light on the nozzle unit 112 or the printing medium P, and a light receiving sensor for receiving light reflected from the nozzle unit 112 or the printing medium P. The defective nozzle detection unit 132 detects the occurrence of the defective nozzle according to the output signal from the light receiving sensor and transmits information on the occurrence of the defective nozzle to the control unit 130 as described in greater detail below. Here, the light emitting sensor and the light receiving sensor can be constructed in an integral form or separately. The construction and operations of the optical sensor are well known to those skilled in the art, and therefore, a detailed description thereof is omitted.

Although not shown in the figures, as an alternative example, the defective nozzle detection unit 132 can transmit a nozzle check signal to the nozzles of the print head and detect the occurrence of the defective nozzle in response to the transmitted nozzle check signals. Such a defective nozzle detecting method is well known to those skilled in the art, and therefore, a detailed description thereof is omitted. In addition, other various apparatuses and methods can be used to detect the occurrence of the defective nozzle.

The defective nozzle detection unit 132 detects the occurrence of the defective nozzle by using one or more of the aforementioned processes. Information on the defective nozzle detected by the defective nozzle detection unit 132 is stored in a memory (not shown), and the control unit 130 controls operations of components to compensate for the defective nozzle based on the defective nozzle information stored in the memory (not shown).

The print head unit 105 is a component for firing ink on the printing medium P to print an image and comprises the body 110 print head 111 provided at one side of the body 110, the nozzle unit 112 provided with the print head 111, and a carriage 106 on which the body 110 is mounted. The body 110 is mounted on the carriage 106 in the form of a cartridge. The feeding roller 115 and paper ejecting roller are pivotally provided to an input side and an output side of the nozzle unit 112, respectively.

Although not shown in the figure, an ink containing space for containing ink can be provided with the body 110. In addition, the body 110 can further comprise chambers provided with driving means (for example, a piezoelectric driving type device and a thermal driving type heater) connected to the nozzles of the nozzle unit 112 to provide a pressure for firing the ink, pipe lines (for example, orifices) for supplying the ink contained in the body 110 to the chambers, a manifold which is a common pipe line for supplying the ink inflow through the pipe lines to the chambers, restrictors which are individual pipe lines for supplying the ink from the manifold to the chambers, and so forth. The chamber, pipe lines, manifold, and restrictors are well-known to those skilled in the art, and therefore, a detailed description thereof is omitted. Alternatively, the ink containing space for containing the ink can be separately provided from the print head unit 105. The ink contained in the ink containing space (not shown) can then be supplied to the print head unit 105 through a transporting member such as a hose.

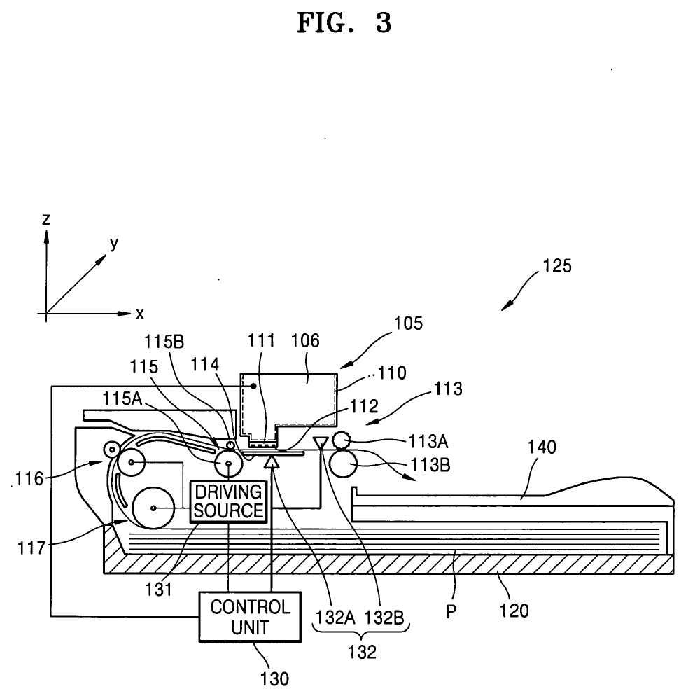

FIG. 4 is a view showing a driving mechanism for a print head according to an exemplary embodiment of the present invention. In FIG. 4, reference numerals N1, N2, N3, . . . denote nozzles provided with the nozzle unit 112, and a nozzle driving mechanism is described, as a nozzle array is exemplified.

Referring to FIG. 4, the driving means 160 is a component for providing a firing force for firing ink droplets and drives the nozzle unit 112 in a predetermined frequency to print an image on the printing medium P. The driving means 160 is mainly classified into two types according to a kind of actuator for providing the firing force to the ink droplets. As described above, one type is the thermal driving type where the ink droplets are fired by using a heater, and the other type is the piezoelectric device type where the ink droplets are fired by using the piezoelectric device. The driving operation of the driving means 160 for driving the nozzles is controlled by the control unit 130 as described in greater detail below.

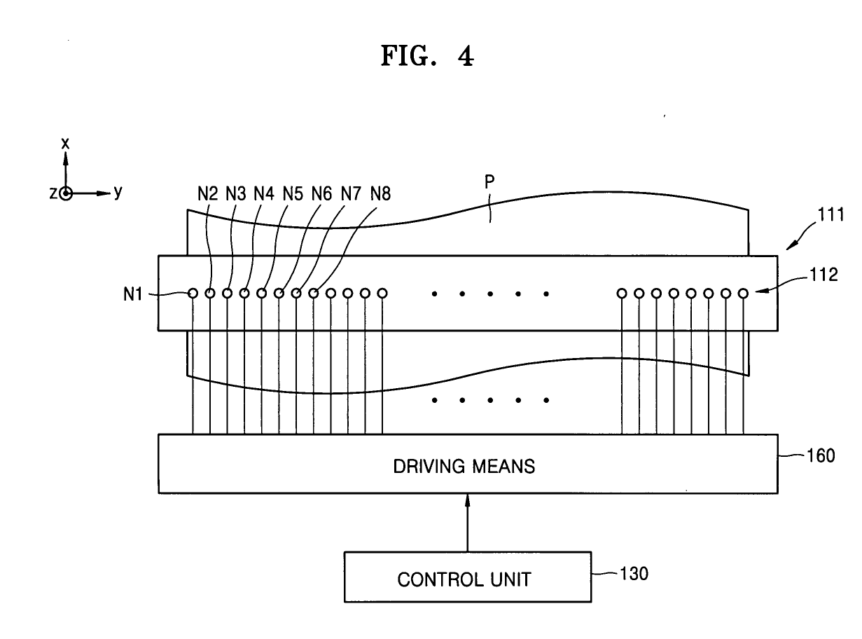

FIG. 5 is a plan view showing a print head according to an exemplary embodiment of the present invention.

Referring to FIGS. 5 and 3, the print head 111 is disposed in a second direction (y direction) about the printing medium P which is conveyed in a first direction (x direction). The print head 111 uses thermal energy, a piezoelectric device, and the like, as an ink firing power source, and is manufactured to have a high resolution by using semiconductor manufacturing processes such as etching, depositing, and sputtering processes. The print head 111 is classified into a shuttle type where the print head 111 reciprocates in a direction perpendicular to a conveying direction of the printing medium P and prints an image, and a line printing type where the print head 111 has a length that is greater than or equal to a width of the printing medium P. Embodiments of the present invention can be applied to either of the shuttle type and line printing type inkjet image forming apparatuses. A nozzle unit 112 for firing ink on the printing medium P and performing printing is provided with the print head 111.

Hereinafter, for the convenience of description, the line printing type print head will be exemplified.

The nozzle unit 112 may be constructed to have a length corresponding to the width of the printing medium P or larger than the width of the printing medium P. As shown in FIG. 5, an embodiment of the present invention comprises a plurality of head chips H where a large number of nozzle columns 112C, 112M, 112Y, and 112K can be formed. In yet other embodiments, each of the head chips H can be manufactured with a single chip corresponding to the length of the print head 111, that is, the width of the printing medium P.

As a plurality of the head chips H are arrayed in a column, a nozzle interval between the head chips H at the boundary region is larger that a nozzle interval between the nozzles arrayed in the same head chip (H), and a region where the ink is not fired may occur. Therefore, preferably, a plurality of the head chips H are arrayed in a longitudinal direction of the print head 111 in a staggered or zigzag pattern. In addition, as shown in the figure, preferably, in order to improve a resolution of the second direction (y direction), the nozzle columns firing the ink of the same color among the nozzle columns 112C, 112M, 112Y, and 112K of each of the head chips H are alternately arrayed. According to the aforementioned array of nozzle columns, ink dots fired from the nozzles of each nozzle column are impacted at positions between the ink dots fired from other nozzle columns, so that the resolution of the second direction (y direction) can be improved.

Although the line printing type printing head 111 having the nozzle unit 112 constructed with a large number of the head chips H is described as an example in the exemplary embodiment, the print head 111 can be constructed as any number of other various types of print heads. For example, the inkjet image forming apparatus according to embodiments of the present invention can include a shuttle type print head. Namely, the print head 111 and the nozzle unit 112 are provided to illustrate one example of an embodiment of the present invention, and therefore, the scope of the present invention is not limited thereto.

In addition, a driving circuit 112D and cables 112E to which driving signals, ink firing power, and image data are transmitted from the control unit 130 (see FIG. 4), are connected to each of the nozzles provided with the nozzle unit 112. Preferably, flexible cables such as a flexible printed circuit (FPC) and a flexible flat cable (FFC) are used for the cables 112E.

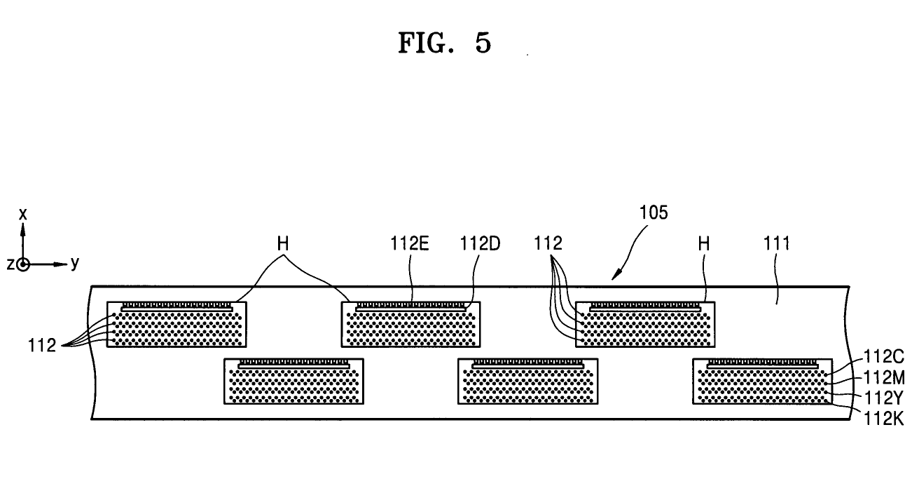

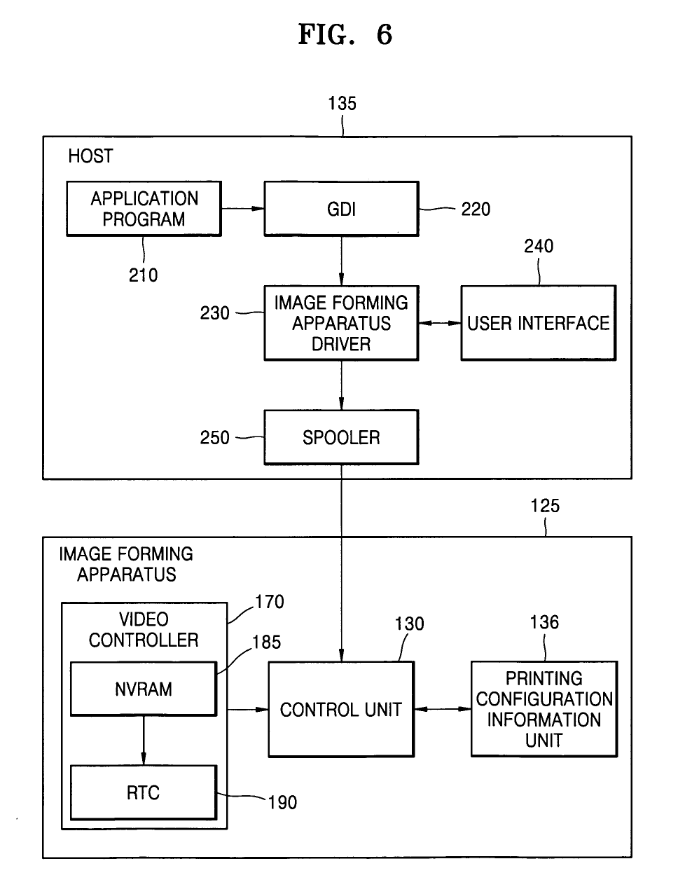

FIG. 6 is a block diagram showing an image forming system according to an exemplary embodiment of the present invention, and FIG. 7 is a block diagram showing a construction of the inkjet image forming apparatus according to an exemplary embodiment of the present invention. Here, the image forming system comprises a data input unit 135 and an inkjet image forming apparatus 125.

Referring to FIGS. 6 and 7, the data input unit 135 denotes a host system such as a personal computer (PC), a digital camera, a personal digital assistant (PDA), and the like, and receives to-be-printed image data preferably in an order of printing pages. The data input unit 135 comprises an application program 210, a graphics device interface (GDI) 220, an image forming apparatus driver 230, a user interface 240, and a spooler 250.

The application program 210 has a function of generating and editing an object which can be output by using the image forming apparatus 125. The GDI 220 which comprises a program existing in an operating system (OS) on the host, receives the object generated by the application program 210, transmits the object to the image forming apparatus driver 230, and generates commands on the object requested by the image forming apparatus driver 230.

The image forming apparatus driver 230 which comprises a program existing on the host, generates commands which can be analyzed by the image forming apparatus 125. The user interface 240 for the image forming apparatus driver 230, comprises a program existing on the host, and provides configuration variables in which the image forming apparatus driver 230 generates the commands. A user uses the user interface 240 to select a printing mode such as a draft mode, normal mode, and high-resolution mode, and a kind of printing medium P such as plain paper, photo paper, and transparent film. The spooler 250 comprises a program existing on an operating system in the host, and transmits commands generated by the image forming apparatus driver 230 to input/output units (not shown) connected to the image forming apparatus 125.

The image forming apparatus 125 comprises a video controller 170, a control unit 130, and a printing configuration information unit 136. In addition, the video controller 170 comprises a non-volatile memory (NVRAM; non-volatile random access memory) 185, an SRAM (not shown), an SDRAM (not shown), a NOR flash (not shown), and a real time clock (RTC) 190. The video controller 170 analyzes the commands generated by the image forming apparatus driver 230, generates associated bitmaps, and transmits the bitmaps to the control unit 130. The control unit 130 transmits the bitmaps generated by the video controller 170 to components of the image forming apparatus 125 to form an image on the printing medium P. Through the aforementioned process, the printing is performed by the image forming apparatus 125.

As shown in FIG. 7, the maintenance unit 122 comprises a unit for maintaining the nozzle unit 112 in a printing standby state in order to implement a high image quality. Although not shown in the figure, the maintenance unit 122 comprises a capping device for capping the nozzle unit 112, a wiping device for wiping the nozzle unit 112, and an ink receiving portion for receiving and storing a small amount of the ink fired from the nozzle unit 112 at the time of a spitting operation. The operation of the maintenance unit 122 is controlled by the control unit 130 as described in greater detail below. For example, when the defective nozzle is detected, the control unit 130 controls a maintenance operating unit 176 to drive the maintenance unit 122.

In a case where the printing is not performed within a predetermined time, or a case where there is a nozzle from which the ink is not fired within a predetermined time during the printing operation, the firing failure may be caused by dried ink on a surface of the nozzle or by an increase in viscosity of the ink. The spitting device removes the increased viscosity ink by spitting a small amount of the ink several times. Namely, in order to prevent the ink from not normally firing due to the drying of the ink firing nozzle, the spitting device spits ink through the ink firing nozzle before or during the printing.

If the amount of the ink remaining on the surface of nozzle unit 112 increases, the trajectory of ink droplets can become deflected, so that the printing quality may become seriously influenced. The wiping device removes any solidified ink or ink remaining around the nozzle by rubbing the surface of the nozzle unit 112.

However, in a case where the inkjet image forming apparatus is not used for a long period of time or in a case of printing standby, the ink of the nozzle unit 112 provided to the print head 111 can become dried or contaminated by dust. The capping device covers the nozzle unit 112 to block an external atmosphere when the nozzle unit 112 is not used within a predetermined time or longer, so that drying or contamination of the ink of the nozzle unit 112 can be prevented. In addition, a suction function denotes a cleaning operation for an ink firing portion by sucking a portion of ink remaining in the nozzle openings of the nozzle unit 112.

As described above, the maintenance unit 122 comprises a unit for maintaining the nozzle unit 112 in an optimal printing condition. The construction and operations of the maintenance unit 122 are well-known to those skilled in the art, and therefore, a detailed description and drawings thereof are omitted.

The control unit 130 can be provided on a mother board of the inkjet image forming apparatus 125 and controls a firing operation of the nozzle unit 112 provided with the print head 111, an operation of the maintenance unit 122, an operation of the printing medium conveying unit, and the like, according to the occurrence of the defective nozzle detected by the defective nozzle detection unit 132. The control unit 130 controls the image data input from the data input unit 135 to be stored in a memory unit 137 and checks whether or not the storing of the to-be-printed image data in the memory unit 137 is completed. For example, when the defective nozzle is detected, the control unit 130 synchronizes components of the driving means 160, so that ink having colors different from the color of the defective nozzle is fired at the compensated position which is a position on the printing medium P printed with the defective nozzle, and ink having the color equal to the color of the defective nozzle is fired at the position or positions adjacent to the compensated position. The operation of the control unit 130 will be described together with the method of compensating for the defective nozzle in greater detail below.

The printing configuration information unit 136 stores a plurality of printing configuration information corresponding to the printing configuration when the image data input from the application program 210 is printed in predetermined printing configurations. Namely, the printing configuration information unit 136 stores the printing configuration information input from the user interface 240 corresponding to the printing configurations. Here, the printing configuration denotes at least one of a printing mode, a kind of printing medium, printing density, resolution, size of printing medium, usage temperature, usage humidity, and sequential printing mode instructions. The control unit 130 controls operations of the driving means 160 and/or the driving source 131 according to the printing configuration information stored in the printing configuration information unit 136 corresponding to the printing configurations.

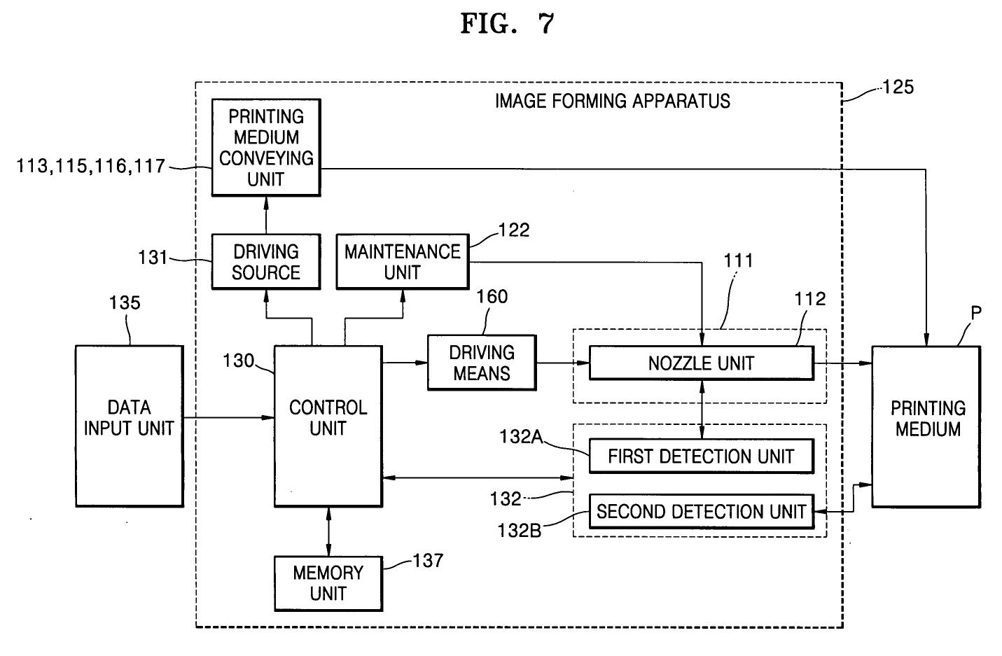

Now, exemplary operations of the control unit 130 will be described in detail with reference to a flowchart of FIG. 8 showing a method of compensating for a defective nozzle according to embodiments of the present invention.

FIG. 8 is a flowchart showing a method of compensating for a defective nozzle in the inkjet image forming apparatus according to an exemplary embodiment of the present invention.

Referring to FIGS. 8, 6, and 7, the defective nozzle detection unit 132 detects the occurrence of a defective nozzle of the nozzle unit 112 at steps (S10) and (S20). Information on the occurrence of the defective nozzle is transmitted to the control unit 130. Since the methods of detecting the defective nozzle of the nozzle unit 112 are described above, detailed descriptions thereof are omitted here.

If no defective nozzles are detected at step (S20), the control unit 130 prints an image by driving the nozzle unit 112 in synchronization with the timing that the printing medium P enters the nozzle unit 112. At this time, the control unit 130 generates control signals for controlling an operation of the driving means 160 to print an image on the printing medium P and outputs the control signals. The driving means 160 receives the control singles and drives the nozzle unit 112.

When a defective nozzle is detected at step (S20), information on the defective nozzle of the nozzle unit 112 is input to the defective nozzle detection unit 132 and transmitted to the control unit 130. The control unit 130 controls an operation of the maintenance unit 122 to perform a maintenance operation for recovering the nozzle unit 112 to the printing standby state at step (S30). Namely, the control unit 130 performs a recovery operation for the nozzle unit 112 such as spitting and suction, that is, a maintenance operation in order to recover the defective nozzle. After the maintenance operation, in order to check whether or not the defective nozzle is recovered, the defective nozzle detection unit 132 again detects the occurrence of defective nozzles at steps (S40) and (S50). After it is checked whether or not the defective nozzle is recovered at step (S50), if a defective nozzle is detected, the control unit 130 then performs an operation of compensating for the defective nozzle.

When the defective nozzle is detected, the control unit 130 analyzes the firing states of the nozzle firing ink at the compensated position (which is a position printed with the defective nozzle), and the nozzles firing ink at the positions adjacent to the compensated position at step (S60). Operation (S60) will now be described in detail using an example wherein the black nozzle of the line printing type print head 111 shown in FIG. 5 is a defective nozzle.

The line printing type print head 111 is fixedly disposed in a width direction of the printing medium P. When the defective nozzle occurs, ink is not normally fired from the defective nozzle. If the defective nozzle is not compensated for, image quality in the conveying direction of the printing medium P deteriorates. Namely, ink is not normally fired at the compensated position, which is a position printed with the defective nozzle. However, ink having colors different from the color of the defective nozzle is normally fired. Namely, in the exemplary embodiment of the present invention, the nozzles which are disposed at the position corresponding to the defective nozzle to fire ink colors cyan, magenta, and yellow, normally fire ink at the compensated position. However, since the nozzles which fire ink at the positions adjacent to the compensated position are not defective nozzles, ink colors black, cyan, magenta, and yellow can be normally fired at the adjacent positions. Namely, in operation (S60), the control unit 130 analyzes whether or not the cyan, magenta, and yellow nozzle unit 112C, 112M, and 112Y fire ink at the compensated position, and whether or not the black, cyan, magenta, and yellow nozzle units 112K, 112C, 112M, and 112Y fire ink at the adjacent positions.

The control unit 130 then fires ink having a color different from the color of the defective nozzle at the compensated position, so that ink fired at the adjacent positions bleeds into ink fired at the compensated position according to the firing state of the nozzles (resulting in ‘inter-color bleeding’). As a result, the defective nozzle is compensated for at step (S70).

In an exemplary embodiment of the present invention, the control unit 130 also fires the ink color equal to the color of the ink fired from the defective nozzle at the adjacent positions. Namely, the control unit 130 fires the ink having the color equal to the color fired from the defective nozzle at the adjacent positions, and fires ink of an arbitrary color (i.e., random color) at the compensated position, so that the ink fired at the adjacent positions and the ink fired at the compensated position are mixed (inter-color bleeding).

Therefore, the ink fired at the adjacent positions and having a color equal to the color of the ink fired from the defective nozzle diffuses into the ink, so that the defective nozzle is compensated.

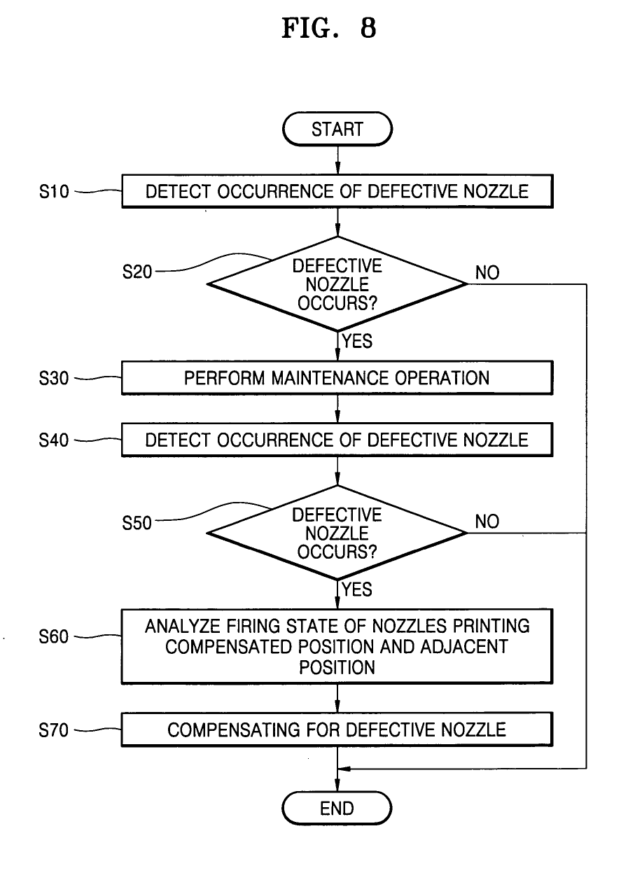

Exemplary embodiments of the compensated position and the adjacent positions are described in greater detail below with reference to the accompanying drawings, including FIG. 9.

In order to achieve the inter-color bleeding effect, preferably, at least one of the inks fired at the adjacent positions and the inks fired at the compensated position has a larger amount than a normal firing amount.

Therefore, the control unit 130 controls the operation of the driving means 160, so that at least one of the inks fired at the adjacent positions and the inks fired at the compensated position has a larger amount than an ink firing amount in a normal case.

In addition, in order to improve a compensation effect, preferably, ink having chroma similar to that of the ink fired at the defective nozzle is fired at the compensated position.

Therefore, the control unit 130 drives the nozzle unit 112 to fire the ink having chroma similar to that of the ink fired at the defective nozzle at the compensated position.

At this time, ink of one color or ink of two, three, or more colors can be fired at the compensated position.

In a case where the defective nozzle is compensated for by using aforementioned inter-color bleeding, the ink dots fired adjacently are mixed. In order to suitably use the compensation effect due to the mixing, preferably, the defective nozzle fires the black ink. Namely, according to embodiments of the present invention, it is possible to further efficiently compensate for the defective nozzle in a case where the black nozzle is a defective nozzle.

In a case where the black nozzle is a defective nozzle, preferably, the black ink is fired at the adjacent positions. The black ink can be fired from the black nozzle, or the black ink can be created by firing the ink from the cyan, magenta, and yellow nozzles at one position (resulting in a ‘composite black’).

In accordance with another embodiment of the present invention, the control unit 130 can determine based on a to-be-printed image and the firing state of the nozzles, whether or not the ink is fired at the adjacent positions and compensates for the defective nozzle by firing the ink having a color equal to that of the defective nozzle at the position where the ink is not fired among the adjacent positions. This is because, if the ink having a color equal to that of the defective nozzle is fired at the position which the ink for implementing image printing is fired among the adjacent positions, the ink corresponding to the printing image and the ink corresponding to the defective nozzle is mixed, so that the image quality deteriorates.

A method of compensating for the defective nozzle according to exemplary embodiments of the present invention will now be described with reference to the accompanying drawings.

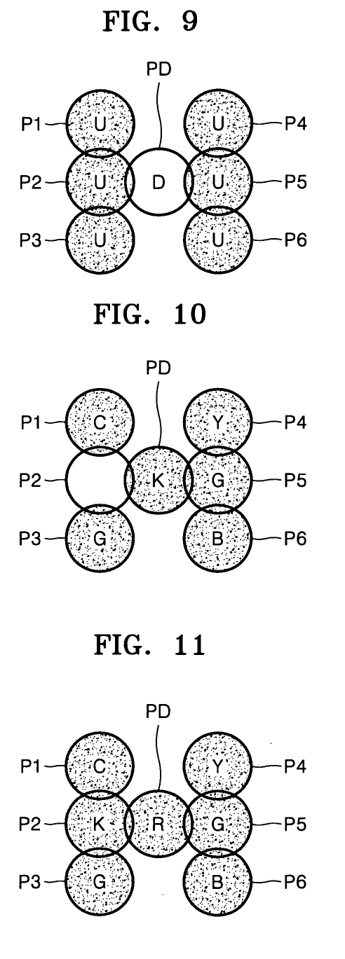

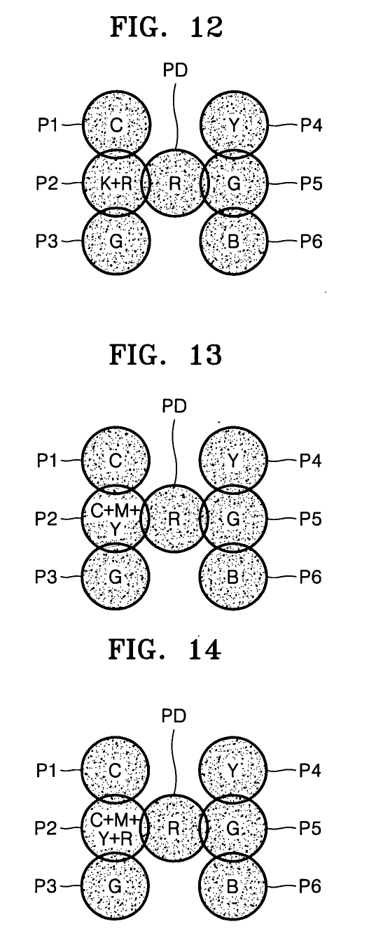

FIG. 9 is a view for illustrating a compensated position and positions adjacent thereto according to an exemplary embodiment of the present invention. FIGS. 10 to 14 are views for illustrating a method of compensating for a defective nozzle according to an exemplary embodiment of the present invention. FIG. 10 is a view showing a to-be-printed print pattern, and FIGS. 11 to 14 are views for illustrating a method of compensating for a defective nozzle by implementing a to-be-printed print pattern shown in FIG. 10 when the defective nozzle occurs. In FIG. 9, reference numeral PD denotes a compensated position which is a position printed with a defective nozzle, and reference numerals P1, P2, P3, P4, P5, and P6 denote positions adjacent to the compensated position. In addition, reference numeral D shows an ink dot which is fired from the defective nozzle and impacted on the printing medium, and reference numeral U shows an ink dot which is fired from an arbitrary nozzle and impacted on the printing medium.

For example, in a case where a print pattern such as the pattern shown in FIG. 10 is printed, since the black nozzle is a defective nozzle, the black ink is not normally fired at the compensated position PD. In the print pattern according to an exemplary embodiment of the present invention, since the ink of cyan, green, yellow, green, and blue colors are fired at the positions P1, P3, P4, P5, and P6 of the adjacent positions, preferably, the black ink is fired at the position P2 in order to compensate for the defective nozzle. Namely, as shown in FIG. 11, the control unit 130 fires the black ink K, which must be fired at the compensated position PD, at the adjacent position P2, and fires an arbitrary ink R at the compensated position PD. Here, the reference numeral R denotes an arbitrary ink color. For example, the ink R can be one of cyan, magenta, yellow, cyan+magenta, magenta+yellow, and yellow+cyan colors. At this time, in order to improve the inter-color bleeding effect, as shown in FIG. 12, an arbitrary ink R in addition to the black ink K can be fired at the position P2. In addition, by increasing the firing amount of one of the inks fired at the position P2 or PD, the inter-color bleeding effect can be improved. In addition, the black ink K fired at the position P2, which is an adjacent position, can be implemented as a composite black, that is, a mixture of a cyan+magenta+yellow ink colors as shown in FIG. 14.

In the aforementioned exemplary method and apparatus embodiments of the present invention, in order to compensate for the defective nozzle, an arbitrary color can be fired at the compensated position, and ink having a color equal to the color fired from the defective nozzle can be fired at the adjacent position or positions, such that the defective nozzle can be compensated.

Unlike conventional methods, according to an inkjet image forming apparatus and method of compensating for a defective nozzle in the inkjet image forming apparatus of embodiments of the present invention, the missing dot of the defective nozzle is compensated for, so that it is possible to prevent deterioration in image quality such as a white band which can be easily perceived by a user. In addition, unlike conventional techniques, according to embodiments of the present invention, defects of other color nozzles, as well as the black nozzle, can be easily and effectively compensated. In addition, according to embodiments of the present invention, by adjusting a firing amount or chroma of the ink fired at the compensated position or the adjacent position or positions, it is possible to improve a compensation effect.

In addition, according to embodiments of the present invention, a defective nozzle can be compensated and used again, so that the life time of a print head can be prolonged.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of compensating for a defective nozzle in an inkjet image forming apparatus having a nozzle unit for firing ink on a printing medium to print an image, comprising:
detecting an occurrence of the defective nozzle in the nozzle unit;
when the defective nozzle is detected, analyzing a firing state of nozzles firing ink at a compensated position printed with the defective nozzle and at a position adjacent to the compensated position; and
compensating for the defective nozzle by firing ink having a color different from that of the defective nozzle at the compensated position according to the firing states of the nozzles to diffuse ink fired at the adjacent position into the ink fired at the compensated position.

2. The method of claim 1, further comprising, when the defective nozzle is detected, performing a maintenance operation to recover the nozzle unit to a printing standby state.

3. The method of claim 2, further comprising, after the maintenance operation is performed, detecting an occurrence of the defective nozzle in the nozzle unit.

4. The method of claim 1, wherein ink having a color equal to that of the ink fired from the defective nozzle is fired at the adjacent position.

5. The method of claim 4, wherein at least one of the ink fired at the adjacent position and the ink fired at the compensated position has a larger firing amount than an amount of normally fired ink.

6. The method of claim 4, wherein ink having chroma similar to that of the ink fired from the defective nozzle is fired at the compensated position.

7. The method of claim 6, wherein a plurality of ink colors are fired at the compensated position.

8. The method of claim 1, wherein the defective nozzle comprises a black nozzle firing a black ink.

9. The method of claim 8, wherein the black ink is fired at the adjacent position.

10. The method of claim 9, wherein if a black nozzle firing a black ink adjacent to the defective nozzle is a defective nozzle, then firing at least one of cyan, magenta, and yellow ink at the adjacent position.

11. The method of claim 9, wherein at least one of the ink fired at the adjacent position and the ink fired at the compensated position has a larger firing amount than an amount of normally fired ink.

12. The method of claim 9, wherein ink having chroma similar to that of the ink fired from the defective nozzle is fired at the compensated position.

13. The method of claim 8, wherein at least one of cyan, magenta, and yellow ink are fired at the adjacent position.

14. The method of claim 1, wherein the step of compensating for the defective nozzle further comprises:
determining, based on a to-be-printed image and the firing states of the nozzles, whether or not ink is fired at the adjacent position; and
compensating for the defective nozzle by firing ink having a color equal to that of the defective nozzle at a position where ink is not fired among the adjacent positions.

15. The method of claim 1, wherein the nozzle unit has a length that is greater than or equal to a width of the printing medium.

16. The method of claim 1, wherein the step of analyzing a firing state of nozzles firing ink at a compensated position printed with the defective nozzle and at a position adjacent to the compensated position comprises:
analyzing whether or not a cyan, magenta, and yellow nozzle unit fires ink at the compensated position; and
analyzing whether or not a black, cyan, magenta, and yellow nozzle unit fires ink at the adjacent position.

17. An inkjet image forming apparatus, comprising:
a print head having a nozzle unit for firing ink;
a driving means for driving the nozzle unit to form an image on the printing medium;
a defective nozzle detection unit for detecting an occurrence of a defective nozzle in the nozzle unit; and
a control unit for controlling an operation of the driving means so that ink having a color different from that of ink fired from the defective nozzle is fired at a compensated position printed with the defective nozzle, and ink having a color equal to that of the ink fired from the defective nozzle is fired at a position adjacent to the compensated position.

18. The inkjet image forming apparatus of claim 17, further comprising a maintenance unit for recovering the nozzle unit to a printing standby state, wherein the control unit operates the maintenance unit when the defective nozzle is detected.

19. The inkjet image forming apparatus of claim 17,
wherein the defective nozzle comprises a black nozzle for firing, a black ink, and
wherein the control unit is configured to control an operation of the driving means to fire the black ink at the adjacent position.

20. The inkjet image forming apparatus of claim 17, wherein the control unit is configured to:
determine, based on a to-be-printed image and firing states of the nozzles, whether or not ink is fired at the adjacent positions, and
control an operation of the driving means to fire ink having a color equal to that of the defective nozzle at a position where ink is not fired among the adjacent positions.

21. The inkjet image forming apparatus of claim 17, wherein the nozzle unit has a length that is greater than or equal to a width of the printing medium.

22. The inkjet image forming apparatus of claim 17, wherein at least one of the inks fired at the adjacent positions and the inks fired at the compensated position has a larger amount than a normal firing amount.
